(19) United States
(12) Patent Application Publication
(10) Pub. No.: US 2024/0264122 A1
(43) Pub. Date: Aug. 8, 2024

(54) HIGH SPEED COMPOUND IMAGING OF TUBULARS

(71) Applicant: DarkVision Technologies Inc, North Vancouver (CA)

(72) Inventors: Reza Zahiri Azar, Burnaby (CA); Jay Hope, Vancouver (CA); Graham Manders, North Vancouver (CA)

(21) Appl. No.: 18/569,611

(22) PCT Filed: Jun. 7, 2022
(86) PCT No.: PCT/IB2022/055284

§ 371 Date: Dec. 13, 2023

(30) Foreign Application Priority Data
Jun. 23, 2021 (GB) 2109035.2

(51) Int. Cl. G01N 29/06; G01N 29/04; G01N 29/22; G01N 29/26

(52) U.S. Cl. CPC G01N 29/069; G01N 29/043; G01N 29/221; G01N 29/262; G01N 2291/044; G01N 2291/106; G01N 2291/2636

(57) ABSTRACT

A device and method used to log images of cylindrical fluid filled tubulars with ultrasound transducers. The transducers operate as phased arrays, insonifying the conduit at plural angles. Reflections from the conduit form images that are combined to create a compound image or correct eccentricity. The frame rate is sped up by defocusing the transmitted beam. This allows the device to log very long pipelines, wells or other tubulars with very high resolution.

### RELATED APPLICATIONS

This application claims priority to United Kingdom Application No. GB2109035.2, filed on Jun. 23, 2021, the disclosure of which is incorporated herein by reference in its entirety.

### FIELD OF THE INVENTION

The present invention related to imaging fluid carrying tubulars, in particular imaging tools and PIGS for pipelines and oil & gas wells.

### BACKGROUND OF THE INVENTION

In wells and fluid carrying pipes, such as oil wells, pipelines, and water delivery infrastructure, there often arises a need to inspect the internal structure for integrity or obstructions. For example, hydrocarbons in production casing may contaminate ground water if there are cracks or deformations in the casing. Similarly, water resources may be lost to leaks in water mains. Ultrasound sensors is a known way of imaging such structures to detect problems thus protecting the environment.

Existing ultrasound tools comprise an array of piezoelectric elements distributed radially around the tool housing. The top surface of each element faces radially away from the tool towards the wall of the conduit. The reflected waves are received by the same elements and the pulse-echo time of the waves are used to deduce the distances to the inner and outer walls and voids therebetween.

In phased array systems, an aperture of several acoustic elements receives delayed electrical pulses to transmit a focused wave, generally perpendicular to a surface of the tubular, as a scan line and then proceed to the next scan line to create a frame. Therefore, the reflections are generally perpendicular from features on the surface. While this is the simplest phased array arrangement, it does mean that non perpendicular features do not reflect signals strongly and some information is lost.

In U.S. Ser. No. 15/737,122 filed Dec. 15, 2017, Darkvision Technologies teaches mechanically moving or electrically steering the phased array to image an area from various viewpoints then adding all the imaged areas to capture the object.

This approach is also slow as there will be hundreds of sequential transmit, dwell and receive events per 360° capture around the tubular. In logging operations, especially in-line-inspections (ILI) of pipelines, the inspection tool (aka PIG) may be moving at 2 m/second over hundreds of kilometers. This creates rate problems for image acquisition, storage and processing.

### SUMMARY OF THE INVENTION

In accordance with a first aspect of the invention there is provided an ultrasonic imaging system for imaging a tubular comprising an imaging tool having a circumferentially-distributed phased array of ultrasound elements. There is an electronic circuit connected to the phased array and arranged to: transmit ultrasound waves radially outwards towards the tubular, which waves are defocused with a coherent wavefront and steered at one of plural different steering angles; and receive ultrasound reflections from the tubular for each of the steering angles, as digital reflection signals. There is a processor arranged to: perform receive-beamforming on the digital reflection signals to create plural steered ultrasound images.

In accordance with a second aspect of the invention there is provided a method of imaging a tubular using an imaging tool having a circumferentially-distributed phased array of ultrasound elements comprising the steps of: deploying the imaging tool through the tubular; transmitting ultrasound waves radially outwards towards the tubular steered at plural steering angles; receiving ultrasound reflections from tubular for each of the plural steering angles as digital reflection signals; performing receive beamforming on the digital reflection signals to create plural steered ultrasound images; and combining the plural steered ultrasound images to create a compounded image of the tubular.

In accordance with a third aspect of the invention there is provided an industrial ultrasonic imaging system for imaging a tubular comprising an imaging tool having a circumferentially-distributed phased array of ultrasonic elements. There are electronic circuits within the imaging tool and connected to the phased array and arranged to: transmit ultrasound waves radially outwards towards the tubular; receive ultrasound reflections from the tubular, as digital reflection signals; store the digital reflection signals on a memory within the imaging tool; and transfer the stored digital reflection signals. There is a computer remote from the imaging tool and arranged to: receive the transferred digital reflection signals; perform parallel receive-beamforming on the digital reflection signals to create ultrasound images; and output the ultrasound images.

In accordance with a fourth aspect of the invention there is provided a method for imaging a tubular using an industrial ultrasonic imaging tool having a circumferentially-distributed phased array of ultrasonic elements, the method comprising: transmitting ultrasound waves radially outwards towards the tubular; receiving ultrasound reflections from the tubular, as digital reflection signals; storing the digital reflection signals on a memory within the imaging tool; transferring the stored digital reflection signals to a computer that is remote from the imaging tool; using the remote computer, performing parallel receive-beamforming on the digital reflection signals to create ultrasound images; and using the remote computer, outputting the ultrasound images.

The following features of preferred embodiments may be combined with the above aspect of invention and with each other.

The processor may combine the plural steered ultrasound images to create a compounded image of the tubular.

The processor may further analyze at least one of the plural steered ultrasound images to detect defects in the tubular.

The waves may be planar waves or diverging curved waves.

The electronic circuit may be arranged to transmit plural waves using different apertures of the ultrasound elements at the same time, without insonifying overlapping areas of an inner surface of the tubular.

The electronic circuit may be arranged to transmit the ultrasound waves to insonify overlapping areas of an inner surface of the tubular from at least two of the different steering angles.

The electronic circuit may be arranged to transmit the ultrasound waves as a continuous wavefront using substantially all of the ultrasound elements.

The plural steering angles may comprise at least one perpendicular wavefront and two opposing, non-perpendicular wavefronts.

The electronic circuit may be arranged to steer a given wave towards an inner surface of the tubular at a substantially consistent angle of incidence along the inner surface.

The electronic circuit may be arranged to steer the waves to contact an inner surface of the tubular at angles of incidence of between 16 and 25°, offset azimuthally with respect to a surface normal of the tubular.

The circumferentially-distributed phased array may be divided into plural segments of subarrays, preferably separated circumferentially by a gap or distributed as a helix or other pattern around the imaging tool.

The circumferentially-distributed phased array may be divided into two or more bands of segments of subarrays, preferably which bands are offset from each other axially with respect to the imaging tool.

The circumferentially-distributed phased array may be divided into plural segments of subarrays, some of which segments are angled partially in an axial direction of the imaging tool.

The processor may perform receive-beamforming on the digital reflection signals in parallel.

The methods or systems may store digital signals from the ultrasound elements of the received ultrasound reflections in a memory of the imaging tool and processing the digital signals on a remote computer, preferably storing the digitals signals as raw Rf signals.

The methods or systems may compare the plural steered ultrasound images to determining eccentricity of the tubular.

The method may comprise performing parallel receive-beamforming on the digital reflection signals to synthesize plural scanlines.

At least one of the steering angles may be selected based on geometry of the tubular to induce a shear wave in the tubular.

### BRIEF DESCRIPTION OF THE DRAWINGS

Various objects, features and advantages of the invention will be apparent from the following description of embodiments of the invention, as illustrated in the accompanying drawings. The drawings are not necessarily to scale, emphasis instead being placed upon illustrating the principles of various embodiments of the invention.

FIG. 1 is end-view of an ultrasound array in a pipe according to a known configuration.

FIG. 2 is a cross-section view of an imaging tool in a borehole.

FIG. 3A is a perspective view of an imaging tool for a pipeline.

FIG. 3B is a close-up view of the section of the imaging tool in FIG. 3A.

FIG. 4 is a cross-section view of the imaging tool in FIG. 3A.

FIG. 5 is a cross-section side view of a damaged tubular.

FIG. 6 is a block diagram for off-line processing of ultrasound data.

FIG. 7 is a flowchart for imaging from plural angles.

FIG. 8 is a circuit block diagram for driving ultrasound transducers.

FIG. 9 is an illustration of imaging from plurals steered angles to better image perforations.

FIG. 10 is an illustration of imaging from plural angles to correct for eccentricity.

FIG. 11 is a cross-section illustrating wavefronts propagating in a pipeline.

FIG. 12 is an illustration of five steered images combined to form a compound image.

FIG. 13 is an illustration of incidence angle selection for imaging a tubular.

FIG. 14A is a simulation of longitudinal wave propagation at a first time.

FIG. 14B is a simulation of shear wave propagation at a first time.

FIG. 15A is a simulation of longitudinal wave propagation at a second time.

FIG. 15B is a simulation of shear wave propagation at a second time.

### DETAILED DESCRIPTION OF THE INVENTION

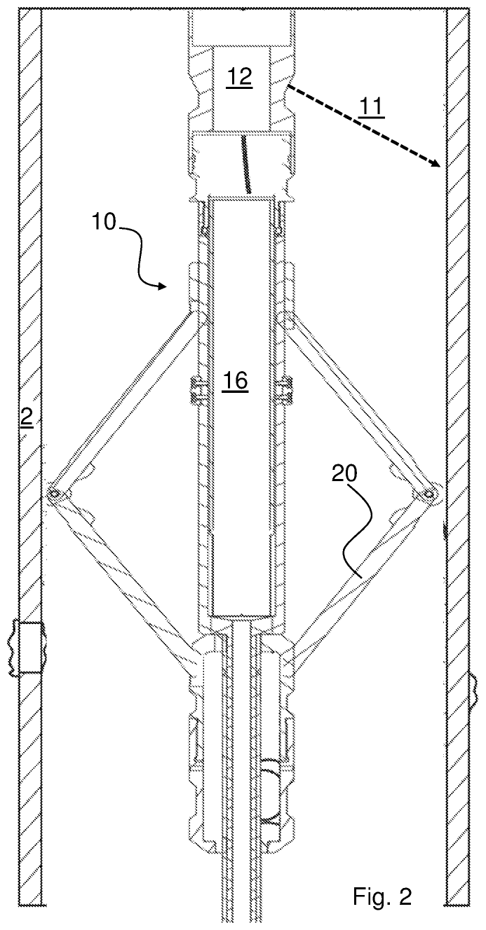

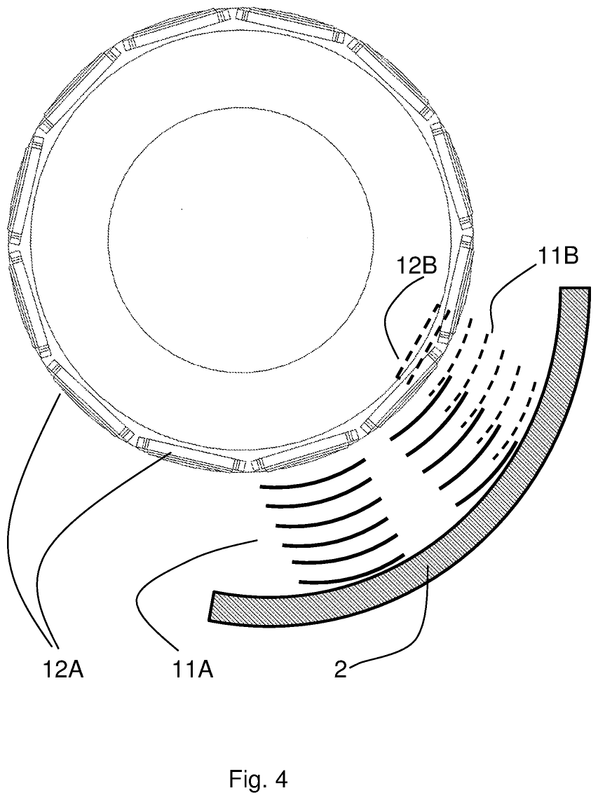

With reference to the accompanying figures, devices and methods are disclosed for capturing, processing, and storing ultrasound reflections from a fluid-carrying tubular by an ultrasound phased array transducer. Overlapping images of the tubular are captured from different angles and combined to make the final image or analyzed separately for defects. The combined image will detect more features as the transmitted wavefronts are likely to hit features perpendicularly from at least one of the plural angles. The combined image will also result in reduced speckle pattern, clutter and acoustic artifacts. In accordance with one embodiment of the invention, there is provided an imaging device 10 for imaging a tubular 2, as illustrated in FIGS. 2 and 4. The imaging device 10 generally comprises a phased array of ultrasound transducers 12, a body 16, a processor 14, and image memory 36. The broader system further includes off-line or cloud computation to create and analyze the images from the raw images stored in memory.

The plural transmitted wavefronts for the same area of tubular will slow down the logging frame rate. To alleviate the frame rate problem, in one approach, a wide transmit pattern (i.e. weakly focused or even unfocused beam) can be used to insonify a much larger target area for each of the plural angles. The reflected waves are then received by plural ultrasound elements in an aperture of the greater array. Parallel beamforming is then used to generate multiple scanlines (e.g. 32 to 128) from each of those insonification events thus significantly increasing the acquisition rate.

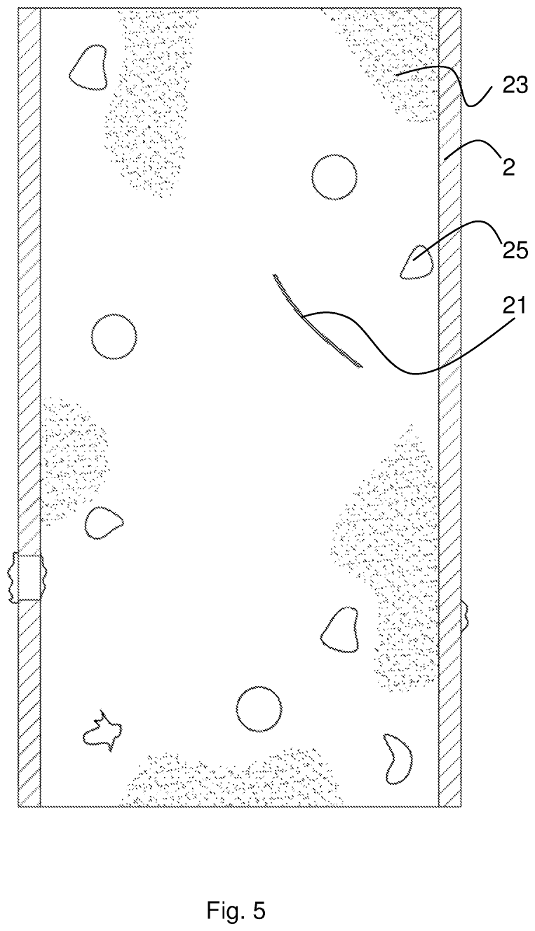

This tubular may be a well/pipe for carrying hydrocarbons or water and having an elongate, cylindrical form factor through which the device can move longitudinally. The device typically also has an elongate form factor and is sized to be deployable within the well or pipe. Wells include cased and uncased wells, at any stage from during drilling to completion to production to abandonment. FIG. 5 illustrates a tubular 2, having rust and corrosion 23, cracks 21, and large pits 25. Preferably these are all imaged by the tool, although the imaging mode is optimized for capturing and sizing the cracks and pits.

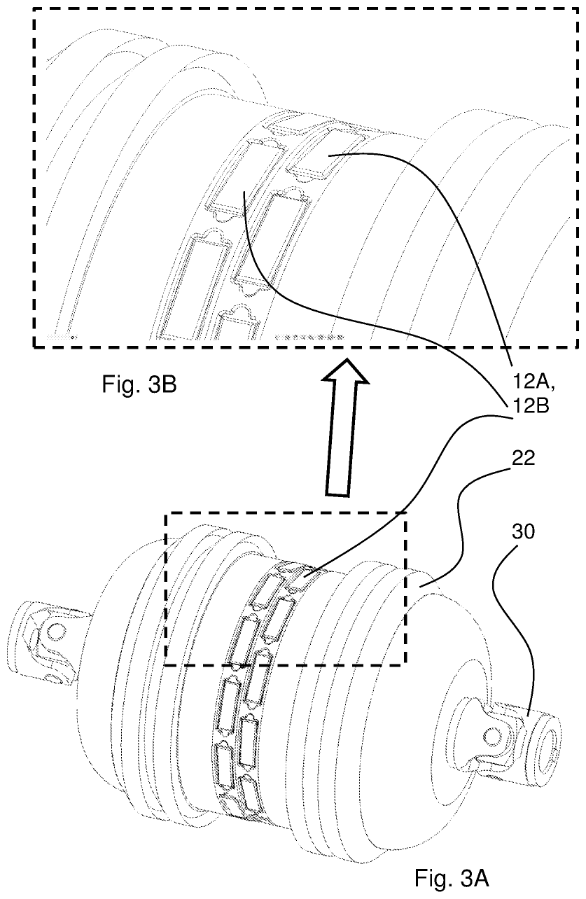

FIG. 2 illustrates an imaging tool 10 in a casing of a borehole, whereby a radial array of transducers 12 transmits waves 11 to reflect off the casing inner and outer surface. FIGS. 3 and 4 illustrates a similar tool 10, this time as a PIG for inspecting a pipeline. In this example, FIG. 3A shows one of several modules having transducers 12 and seals/wipers 22 in a pipeline, the modules connected to each other by coupling 30. Other modules may provide battery power, additional sensing, and computing functions.

FIG. 3B is a close up of the transducer arrangement and FIG. 4 shows these transducer segments in a cross-section end view. The ultrasound transducer 12 may comprise plural ultrasound segments 12A, 12B . . . 12N distributed around the circumference of the imaging tool, each segment comprising a subarray of transducer elements. With respect to the longitudinal axis of the tubular and tool, the transducers may be axially angled (i.e. forwards or backwards of the direction of tool travel) to detect different features, such as cracks that are easier to detect from one angle than another. This longitudinal angle is fixed by the shape of the transducer. The plural segments of transducer arrays are placed preferably axially-midpoint between the seals 22 that engage the pipeline, so as to keep the transducers centralized as the PIG moves around bends.

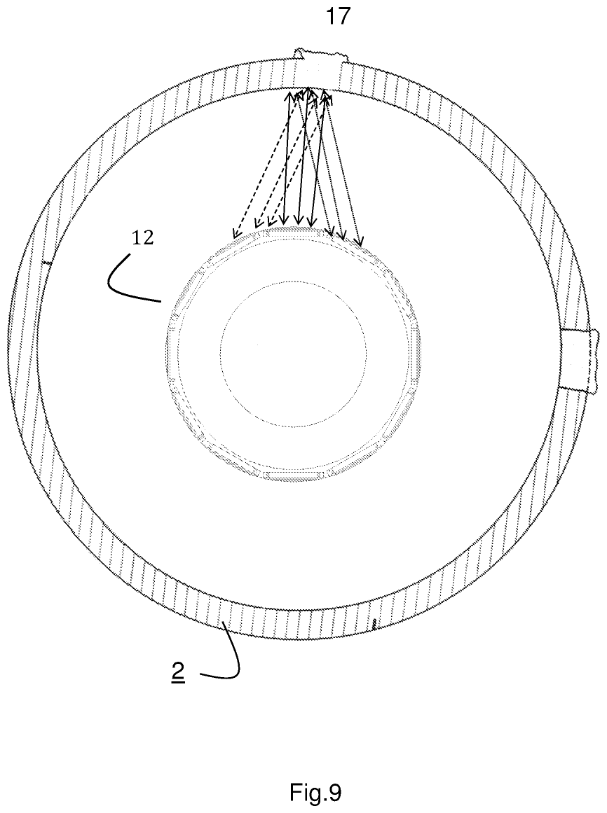

In the azimuthal direction, the wavefront is steered by delays sent to driving circuits coupled to the elements of the array to create plural steered transmit wavefronts 11, providing different angles of incidence upon the tubular surface. As seen, in FIG. 9, a single feature 17 (perforation) in the tubular 2 is sonified from multiple (azimuthal) angles of incidence, two of which catch the left or right outlet flares of the perforation and one that indicates the central area is void. At least one of the voids and outlet flares are missing from each of the steered wavefronts. The combined image captures the feature in much better resolution. The image from each steered wavefront may be analyzed separately to detect features captured from that steered angle.

### Transmit and Steering

In ultrasound arrays, discreet omnidirectional pulses are emitted from the plural transducer elements, which waves interfere constructively and destructively to produce a wavefront moving in the direction of the scan line. As known in the art, altering the timing of the pulse at each transducer element, can steer and focus the wavefront. In steering, the combined wavefront appears to move away in a direction that is not orthogonal from the transducer face, but still in the plane of the array. In focusing, the waves all converge at a chosen distance from the elements. The location of the convergence is the focal point.

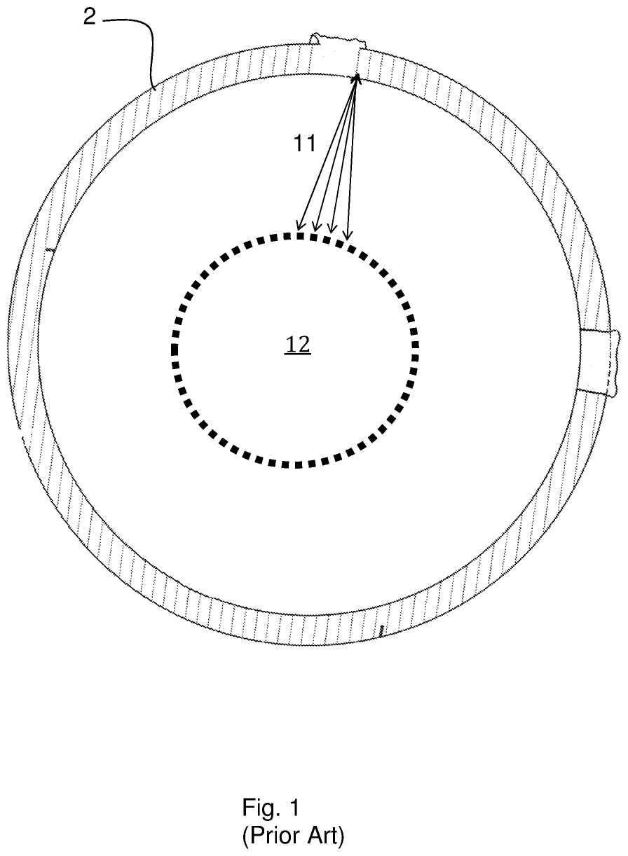

The transmitted wave may or may not be focused at a point on the surface to be imaged. It could be stated as ‘weakly focused,’ ‘defocused,’ ‘unfocused,’ ‘plane wave’, ‘curved wave’, ‘spiral’, ‘divergent,’ or ‘non-convergent’ in as much as the waves have some theoretical focal point far beyond the surface. Thus the sonified area is large and the imaging frame rate is increased compared to prior art focused beams per FIG. 1. Advantageously, the reflected beam comprises plural features of interest that can be delineated and captured by the receive-side beamformer.

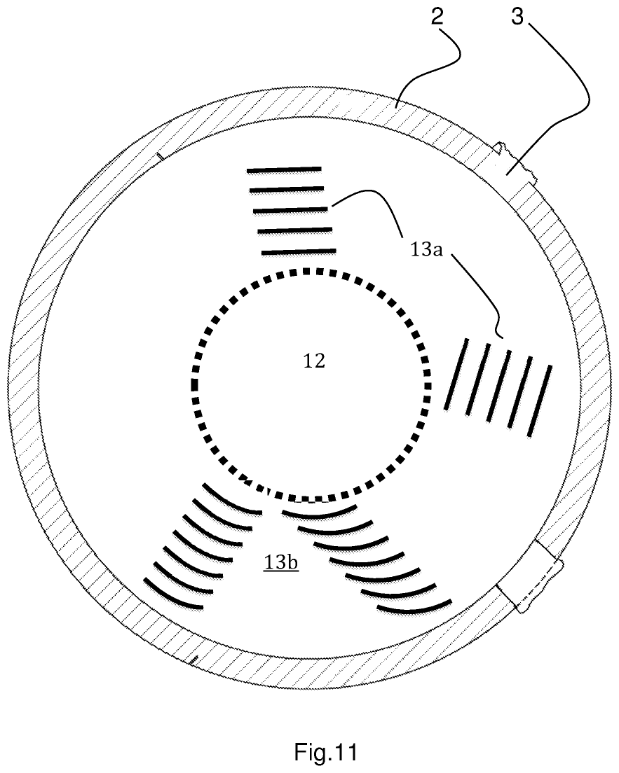

As shown in FIG. 11, the transmitted wave may be a plane wave or curved, the former having a flat front (13a) and the latter having a front that is substantially curved or arc-shaped (13b). Curved/arc-shaped waves can be seen as the polar coordinate equivalent of planar waves. These shapes are created by phase delays set in the FPGA and computed by the onboard CPU. Notably, these wavefronts do not converge or focus on the surface of the tubular 2.

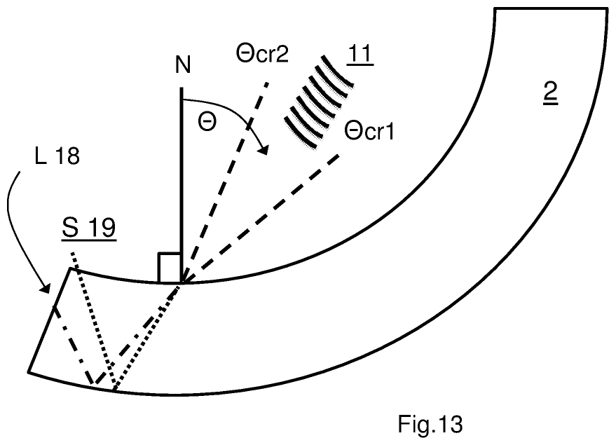

As seen in FIG. 13, when the wavefront of wavefront 11 hits the inner surface of the tubular 2, some of the energy penetrates and refracts, assuming the incidence angle ⊖ (from surface normal N) is less than critical angle ⊖cr1. The refraction depends on the speed of sound of the fluid and metal, as dictated by Snell's Law. Some portion of this energy is a shear wave 19 and some is a longitudinal wave 18. In order to return reflections from cracks, it is desirable to have some shear component, as this wave mode and direction is optimal for reflecting off of cracks and back towards the transducer. If the incidence is greater than a second critical ⊖cr2, most of the energy will be shear wave. Advantageously, this simplifies image processing of the reflections because additional signal modes do not have to be considered. Thus, there is a narrow range of incidence angle that is optimal. This is even a more complicated request when logging a curved tubular at high speed.

The transmitted wavefront from the transducer to a curved tubular 2 is preferably curved as well, rather than a flat plane wave. Preferably the curved wavefront hits the inside of the tubular at the same angle of incidence along the whole area of sonification. This provides two advantages: 1) consistent reflection strength from the inner surface and 2) consistent creation of a shear wavefront within the metal pipe.

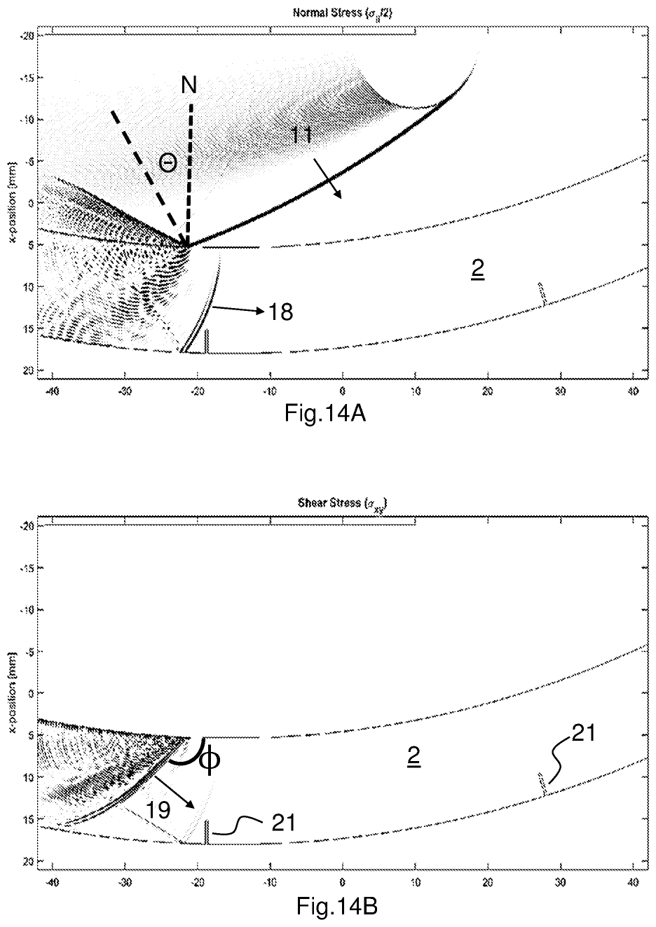

The simulation of FIG. 14A shows transmitted curved wavefront 11 travelling towards the tubular 2 and making an instantaneous angle of incidence ⊖ with respect to the surface normal N. In the metal of the tubular longitudinal wave 18 and shear wave 19 (see FIG. 14B) proceed in the direction shown. A suitable angle of incidence ⊖ is between 16 and 25°, assuming the tubular is steel, and the fluid is water or oil.

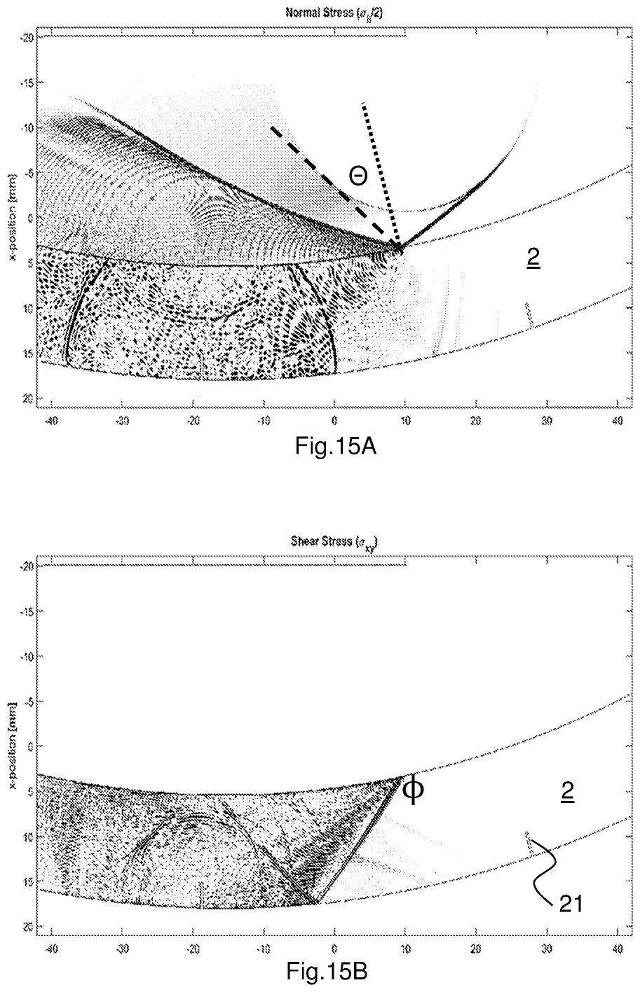

As shown in FIG. 15A, the transmitted wavefront continues to insonify the tubular, at the same angle of incidence ⊖. Note that the wave is defocused at the surface and returns reflections from all features within the area, which are resolved in post-processing. As a result, the shear wave 19 proceeds at the same relative angle ϕ within the metal. This shear wave reflects off cracks 21 and back to the transducer.

The wavefront generally follows that of a spiral, which depends on steering angle, Speeds of Sound, pipe radius, eccentricity, refractions, shear critical angles etc. The equation also depends on the geometry of the transducer area, which itself may be curved or flat. The following pseudocode is an example of such a calculation:

% Determine the tangent vectors and normal vectors from the input array
% points
array_tangents = diff(array_pts);
element_separation = sqrt(sum(array_tangents.\hat{ }2,2));
array_normals = rotateVectorsDegs(array_tangents,-pi/2);
array_normals = array_normals./sqrt(sum(array_normals.\hat{ }2,2));
% Vector from the circle centroids to each element in the array
element_vector = array_pts − curve_centroid;
% Length of the above vectors
element_radius = sqrt(sum(element_vector.\hat{ }2,2));
% Unit vetor of above vectors
element_uvector = r_element./element_radius;
% Solve triangle using the sine rule
gamma =
pi-asin(curve_radius./element_radius*sind(incidence_angle));
% Get the vector that points from each element to where the ray intersects
% the curve
element_curve_vector = rotateVector(element_uvector,pi-gamma);
% These are the steer angles for each solution
alpha =
ccwAngleBetweenVectors(array_normals,element_curve_vector);
% dt is how long to wait from firing element i to element i+1
dt = element_separation.*sin(alpha)/c_ref;
% For the total delay from the first element use cumsum
tx_delays = cumsum(dt);
% Subrtract the lowest value in tx_delays. This will give only positive
% values
tx_delays = tx_delays − min(tx_delays);

### Receive Beamforming

The reflections from the tubulars are received at the transducers, being the same transmitting aperture or a different aperture usually near to the transmitting aperture. The electrical signals of the reflections may be stored in raw form for later, offline beamforming and image reconstructions. Alternatively, the signals are beamformed in real time and the reconstructed image is stored on the tool.

Receive beamforming is understood by persons skilled in the art of ultrasound. In broad terms, the processor uses plural phases delays, pre-stored in a memory (e.g. look-up-table) that convolve/shift the signals based on different focal depths. These signals are combined to reconstruct the final image, whereby weakly focused reflections get diluted and strongly focused reflections are reinforced. As an example, “Delay and Sum” beamforming technique can be used for this purpose.

### Parallel Beamforming

In conventional imaging, images are formed by beamforming one line at a time. This will drastically reduce the acquisition rate. In order to speed up the beamforming, the same channel data can be used with slightly different delays in order to generate multiple lines, which in preferred embodiments can be extended to generate an entire image slice around the tubular from a single transmit event. This is done by running parallel beamforming on all the scan lines at the same time. This is computationally intensive but allows for much faster image reconstruction.

For such a parallel beamforming operation, a wide (or complete circumferential) wavefront is transmitted towards the tubular and reflections are received on substantially all transducers, which reflections are stored. In post-processing, parallel receive-beamforming is performed on the stored signals to estimate a signal for each scanline. Phase delays are set for each element in the aperture of the scanline to adjust the received signals to synthesize the scanline. Plane wave imaging scarifies the transmit focus but is able to significantly improve the frame rate. For example, if 400 lines are used to generate the entire image using conventional imaging at 25 Hz (i.e. acquiring one line at a time), plane wave imaging can be used to improve the frame rate 400 times (i.e. 10 KHz) as it only uses one transmit to generate the entire image (per steering angle).

### Compounding

After reconstructing each angle, the combined image can be put together using summation of data in the overlapping zone. The summation can be coherent (using Rf data) or envelope date (B-mode). The receive beamforming reconstruction will depend on the transmit delays and geometry of the transducer array.

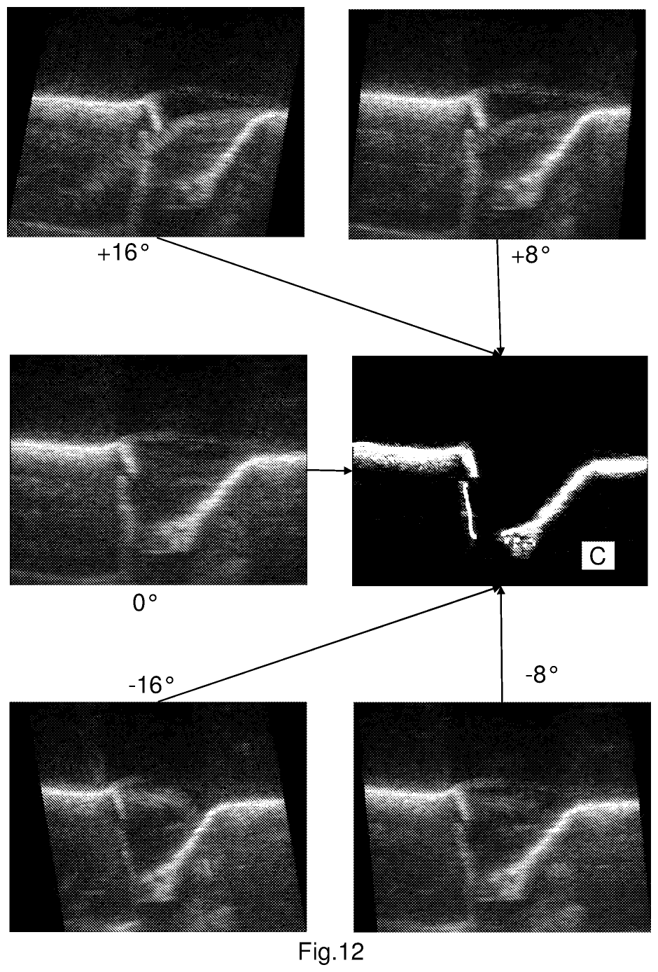

After areas of the tubular or objects therein are captured from plural angles and then receive beamformed to create plural reconstructed images, the step of compounding combines each of these reconstructed images to create a compounded image. The individual angled images are shifted to the same locations, and corresponding pixels in each image are summed to create pixels of the compounded image. FIG. 12 illustrates five images 0, +8°, −8°, +16°, −16° that have captured a damaged pipe from different angles. The compounded image C removes noises that are not coherent in the individual images, reinforces reflectors seen in plural angles, and smooths over glints present in only one of the images.

The steering angles used depend on the geometry of the transducer (element size and element spacing, also known as pitch). For proper steering, ideally the element spacing or pitch is half the imaging wavelength where wavelength can be calculated as follows:

$$\\ Lambda ( wavelength ) = Speed of sound in medium / Ultrasound Frequency$$

$$\\ Wavelength = 308 microns = 1540 m / s / 5 MHz$$

This means the ideal element spacing would be 150 microns in this example. This will allow steering the beam to up to 45 degrees. When this condition is not satisfied the steering angle will be limited, in some cases to a maximum of ±10°.

### Overall Imaging Method

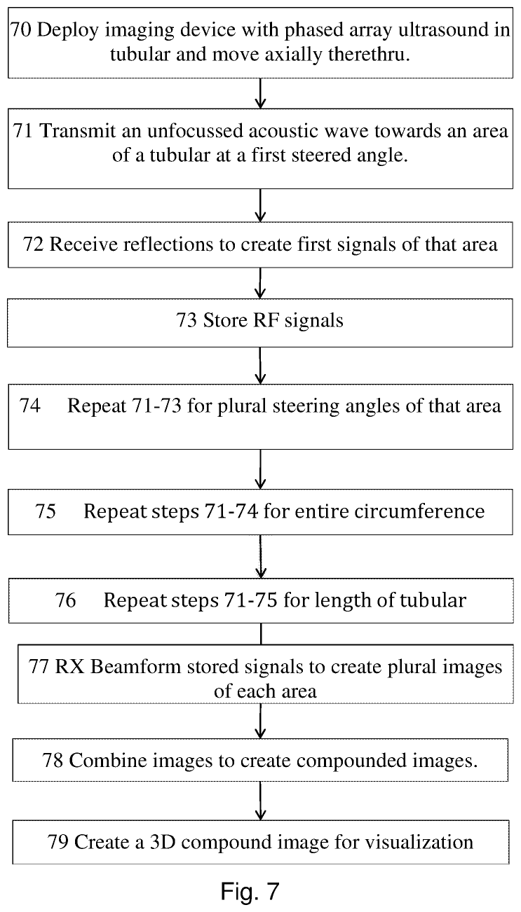

FIG. 7 provides a flowchart for imaging the tubular from plural angles. At initial step 70, the device is placed inside the tubular and moved therethrough. This may be by wireline when downhole or by launcher and pumped in a pipeline. During the capture process at 71, the transducers transmit unfocussed acoustic waves toward the tubular at a first steered angle (e.g. one of −8°, 0°, +8°). The transducer then received reflections from the tubular surface and defect features to create first signals (step 72), which are stored in on-board memory (step 73).

These transmission and receiving steps are repeated for the other steering angles on the same area of the tubular (step 74). The above capture process is also performed all around the device to capture a 2D cross-sectional slice of the tubular, either simultaneously or sequentially (step 75). As the device moves through the tubular, the transducers continue capturing along the length of the tubular (step 76) to complete the third dimension of the capture. Once the device has been recovered out of the tubular, the signals are uploaded for processing. The processor receive beamforms the signals, preferably using parallel beamforming, to create plural images of each area (step 77), one image for each steered transmission.

At step 78, these images may be combined to create compound images for a given area of the tubular, and even stacked to create a 3D compound image of the whole tubular for visualization (step 79).

Optionally each of the (uncompounded) images can be analysed separately by a computer to detect defects. This approach is useful for concentrating on detecting defects that are highly reflected at a particular steering angle. For example, a seam weld or longitudinal crack may be best captured by the +16° steered transmission, without the clutter of the other angles.

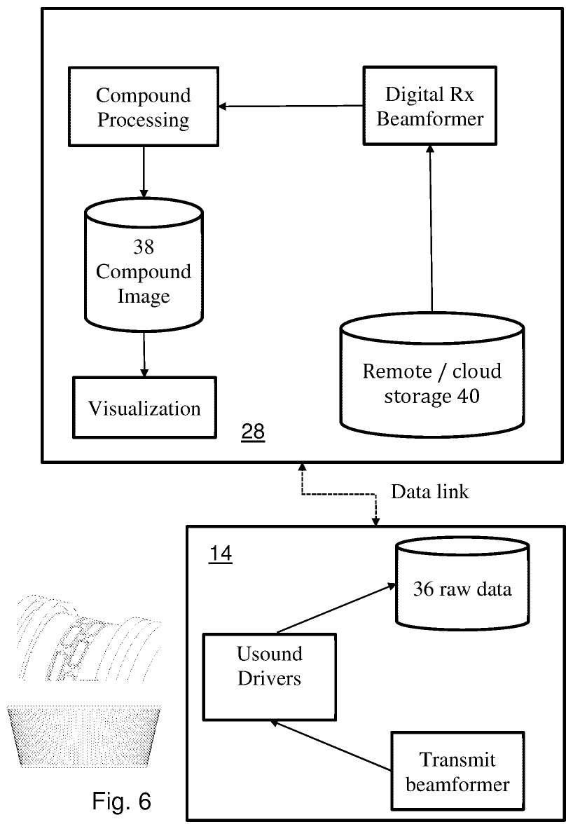

FIG. 6 is a block diagram of components of the device's on-board processor 14 and remote computing system 28. The raw image data is initially stored in memory 40, which could be local or cloud storage). This may be Terabytes of data. Instructions running on the remote processor include modules for digital receive beamforming, compound processing, and visualization. Intermediary images, such as a single beamformed image or the compounded image may be stored on the same or separate storage 38. This shows a preferred division of resources for the method described above. However, as computing resources improve, certain processes could be moved onto the device, such as beamforming and compounding. This could also be done during the downtime of the device, when not actively imaging. In this manner, the recovered device is ready to upload fully compounded images to the remote computer for immediate visualization.

### Multiple Imaging Directions

To further improve time-resolution and speed up the frame rate, the imaging tool may be arranged to transmit several wavefronts simultaneously using several, different apertures or transmit all around the tool simultaneously, preferably using substantially all of the ultrasound elements.

Circumferentially distributed segments may be divided into two or more circumferential bands A and B, axially spaced apart, as shown in FIGS. 3A and 3B. Alternatively, segments may be helically arranged around the tool housing. This allows there to be azimuthal overlap in the sonified areas on the tubular, while avoiding acoustic cross-talk between neighboring segments in a given band. There may be a physical gap between the neighboring segments in a band.

As shown in cross-section of FIG. 4, segments 12A (solid outline) may simultaneously transmit scan lines 11A towards respective areas of the tubular 2, preferably at a similar steering angle with respect to each segment. Thus, there is a gap, here between sonified areas to avoid cross-talk. This gap is then imaged immediately after by the segments 12B (dotted outline) with scanline 11B (dotted lines), in the second half of the frame. Alternatively or additionally, this gap may be imaged by neighboring segments steered towards that gap at opposite steering angles, ±⊖.

Thus, in one example, a single frame may comprise the transmission of all segments 12A at several synchronized steering angles (e.g. 0°, 15°, then −15°), followed by all segments 12B at several synchronized steering angles (e.g. 0°, 15°, then −15°). The compounded image will capture the whole circumference of the tubular from multiple angles. Because the tool is moving quickly during the frame, signals in the received images are offset to create the compounded image. This can be done using precise timestamps for each capture to combine images later, or by offline registration of the same features and shifting the signals in time to combine the images.

### Downhole Operation Example

In one example, a downhole casing having a diameter of 122 mm (i.e. circumference 383 mm) is logged by a 96 mm diameter tool having 384 elements and moving at 10 meters per minute. The elements are only 13 mm away from the surface, which provides low attenuation through the fluid and still provides the geometry to achieve sufficient steering for compounding. The surface can be scanned at a resolution of better than 1 mm using conventional focused, uncompounded imaging. In this setup, the acquisition rate needs to be 167 fps (i.e. 10/60 m/s with 1 mm frame spacing).

Increasing the number of steering angles to five will:
1. reduce the speed of tool by a factor of 5;
2. reduce the resolution by increasing the frame spacing to 5 mm; or
3. increase the requirement for acquisition rate to 960 fps.

The first two of the above three scenarios, are not desirable from an operations and quality perspective. The last option, on the other hand, will maintain the tool speed and resolution but requires the acquisition rate be sped up by the same factor. This is where multi line acquisition (or parallel acquisition), using slightly defocused (or unfocused) waves can be used to solve these inherent contradictions. By beamforming at least five scan lines for each transmit, the tool can increase the frame rate and maintain the tool speed and frame spacing by compounding.

In another example, a large pipeline having a diameter of 1220 mm (i.e. circumference 3833 mm) is logged by a 1140 mm diameter PIG having 4096 elements and moving at 2 m/s. Thus the operation is much faster and covers more surface area. The elements are only and 20 mm away from the surface, which provides low attenuation through the fluid and still provides the geometry to achieve sufficient steering for compounding. The surface can be scanned at a resolution of better than 1 mm using unfocused, uncompounded imaging. In this setup, the acquisition rate may be 2,000 fps (i.e. 2 m/s with 1 mm frame spacing) when only single transmit angle is used. Increasing the number of steering angles to 5 will increase the necessary acquisition rate to 10,000 fps. In the case of multiplexing the transducers, this frame rate will be even higher.

### Ultrasound Transducer Probe

The imaging tool's ultrasound probe 12 comprises a plurality of acoustic transducer elements, preferably operating in the ultrasound band, preferably arranged as an evenly spaced one-dimensional array. The probe may comprise one array or multiple array segments that act together to capture a radial slice of the whole tubular. The surface of the array or each array segment may be flat (see FIG. 3A) or curved (see FIG. 2).

The frequency of the ultrasound waves generated by the transducer(s) is generally in the range of 200 kHz to 30 MHZ, and may be dependent upon several factors, including the fluid types and velocities in the well or pipe and the speed at which the imaging device is moving. In most uses, the wave frequency is 1 to 10 MHZ, which provides reflection from submillimeter features. The transducers may be piezoelectric, such as the ceramic material, PZT (lead zirconate titanate). Such transducers and their operation are well known and commonly available.

Each transducer array is made up of hundreds of elements, depending on the size of the pipe or well, preferably comprising between 256 to 4096 elements. The logging speed and frame rate determines the axial resolution. Multiple transducer elements, per aperture 15, operate in a phase delayed mode to generate a scan line.

In the case of pipeline logging, the large diameters make it preferable to have a large diameter imaging tool (i.e. PIG) with a large number of ultrasound elements distributed over the tool's circumference, more preferably using a high number of scan lines. This brings the transducers closer to the surface to improve signal strength and maintain a high frame rate. As shown in FIG. 4, the probe may comprise 16 transducers arrays, each having 256 elements.

FIGS. 2 and 5 show an embodiment having a radial array 12, arranged in a ring or frustoconical geometry. There may typically be 128 to 1024 elements evenly distributed around the tool's circumference. This embodiment is well suited to logging wellbores, which tend to be narrower than pipelines.

By way of example, the transmission step may include selecting the elements in the aperture, calculating beam steering timings, loading the pulse timings from the FPGA 84, activating the pulser 81 and MUXes 82 to pulse all elements. The dwell period may be set by the operator based on the expected diameter of the pipe and speed of sound in the well fluid. The Rx window may be set to capture the first reflected pulse from the inner radius of interest until the last element has received the last pulse that could reflect off the outer radius of interest.

The aperture 15 is a set of neighboring transducer elements that individually contribute towards the constructive wavefront and increase its acoustic energy. There may, for example, be 32 or 64 elements in the aperture that are selected from the whole array by multiplexors. Normally these are a symmetrical set of elements opposite the pipe area to be sonified, i.e. the sonified spot and aperture center have the same global azimuthal angle.

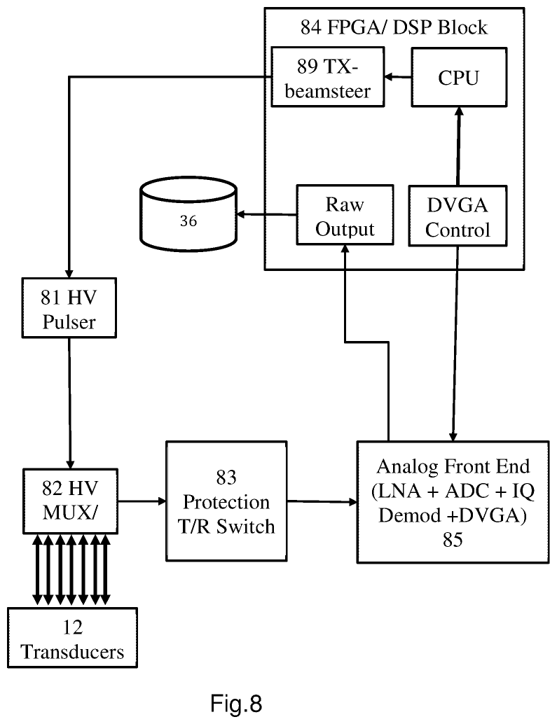

FIG. 8 shows an example circuit dedicated to transmitting, receiving and processing ultrasound waves. These circuits are common in ultrasound imaging and the skilled person is assumed to be familiar with chips, such as LM96511 from Texas Instruments. An FPGA has dedicated circuits for DVGA control, data bus control, and calculating transmit (Tx) steering delays. These delayed pulses are sent to high-voltage pulser 81, which is switched to the selected transducer elements 12 by multiplexer 82.

The received reflection signals at the transducers are analogue and converted to digital by ADC 85. Protection switch 83 prevents the high voltage pulses connecting to the ADC. The raw, digital data output of FIG. 8 is written to Data Memory 36.

Without loss of generality, each of these components may comprise multiples of such chips, e.g. the memory may be multiple memory chips. For the sake of computing efficiency, several of the functions and operations described separately above may actually by combined and integrated within a chip. Conversely certain functions described above may be provided by multiple chips, operating in parallel. For example, the LM96511 chip operates eight transducers, so four LM96511 chips are used to operate an aperture of 32 transducers.

Each of the transducer segments 12A in FIGS. 4 and 3A may be connected to their own driver, memory and processing circuit. This circuit can select and drive an aperture of plural elements in that segment to steer a wavefront towards the tubular 2. Thus the segments may be operated independently from each other. The device may increase the frame rate by transmitting multiple simultaneous wavefronts, one from each of several segments.

The term ‘processor’ is intended to include computer processors, cloud processors, microcontrollers, firmware, GPUs, FPGAs, and electrical circuits that manipulate analogue or digital signals. While it can be convenient to process data as described herein, using software on a general computer, many of the steps could be implemented with purpose-built circuits. In preferred embodiments of the present system, the imaging device's processing circuit provides signal conditioning, data compression and data storage, while the remote processor 28 provides receive beamforming, compounding, and rendering.

It will be appreciated that the various memories discussed may be implemented as one or more memory units. Non-volatile memory is used to store the compressed data and instructions so that the device can function without continuous power. Volatile memory (RAM and cache) may be used to temporarily hold raw data and intermediate computations.

### Remote Processing

The remote processor 28 may be located far from the tubular and imaging tool to permit offline image processing at a convenient location and time. Upon completion of logging the tubular, the tool is retrieved and connected to telecommunication means to download the ultrasound data to some external memory 40, which may be co-located with the remote processor or cloud storage accessible by that remote processor. Typically there will be an intermediary computer located at an operations site and controlled by a technician to download the tool's data and then send it to the remote storage 40. The separation of the processor 28 and tool 10, provide a way to separate the processing in time and location.

### Rendering

The reconstructed, compounded images (i.e., in radius, azimuth dimensions) may be stitched together, as the tool progresses axially (i.e. Z axis) along the tubular to create a 3-D image or geometric model of the tubular.

A geometric model represents the surface features spatially (in radial and depth coordinates) and may be stored or displayed in their native polar form or unrolled as a flat surface. The processor can select a portion of the tubular to display to a user.

The 3-D image data may be reduced to a 2-D surface image, where each pixel in ⊖, Z represents the radius of the reflection from the tool. This simplifies analysis and data storage, while providing important information about tubular shape, surface corrosion or wall loss.

### Centralizing

The imaging device 10 may include one or more centralizing elements for keeping the imaging device in the center of the wellbore. FIG. 2 illustrates a device comprising a centralizer 20, wherein the centralizing arms extend outwardly and abut the inner wall of the well casing or pipe 2 to keep the device in the center of the well or pipe. They may be two centralizers, one before and one after the array to be centered. Similarly, seals of a PIG in a pipeline tend to keep the imaging tool centralized.

The device is ideally concentric with the conduit, i.e., the longitudinal axis of the imaging device is perfectly aligned with the longitudinal axis of the well or pipe. Therefore, scan lines radiate out from the array, arriving with the intended focus, location and angle of incidence, before reflecting back to the transducers.

However, in reality, the device tends to be off-center of the well (i.e. the longitudinal axes are parallel but not aligned), a condition called eccentricity. This may be because the centralizers 20 are not working correctly, or the weight of the device pulls the device below the longitudinal axis of the pipe in horizontal orientations. Also, the pipe itself may be non-circular (e.g. deformed) due to stresses applied to it.

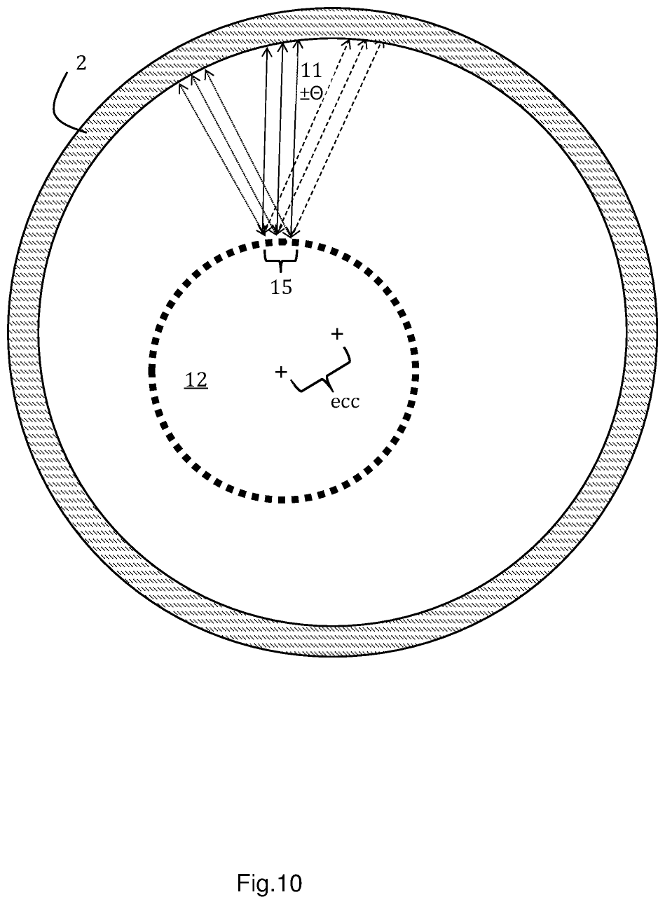

In one exemplary application of the disclosed method, plural steering angles may be used to image the tubular when the tool is eccentric and compensate for this. FIG. 10 demonstrates a radial imaging array 12 that is eccentric with respect to the tubular 2. Aperture 15 transmits plural waves 11 radially-outward with some steering variation ±⊖ from perpendicular.

One of the steered waves 11 will be more perpendicular to the surface of the tubular 2 than the other waves and will thus return stronger reflections. In FIG. 10, the solid lines are perpendicular to the aperture normal but the dotted lines to the left are perpendicular to the tubular 2. The steered angle of the strongest signal increases with component of eccentricity in that perspective and can be used to infer the scalar (ecc) amount. After comparing images from at least two steering angles, in particular looking for the angle with the strongest reflections, for all scan lines in the frame, the processor can determine the eccentricity as a vector (ECC) for the whole array with respect to the tubular.

The visualization processing may use the image from steering angle having the strongest overall reflections for that portion of the tubular. For example, in FIG. 11, the dotted line (left) is most orthogonal to the tubular surface 2 and thus return the most acoustic energy. The visualizer stitches together each of the selected images that has the strongest reflections to render an image of the tubular for the user.

Further information on ultrasound beam forming can be found in the following: Zemp R, Insana MF. Imaging with unfocused regions of focused ultrasound beams. J Acoust Soc Am. 2007; 121(3):1491-1498. doi:10.1121/1.2434247; and Freeman S, Li PC, O'Donnell M. Retrospective dynamic transmit focusing. Ultrasound Imaging. 1995 July; 17(3):173-96. doi: 10.1177/016173469501700301. PMID: 8772263.

1. An ultrasonic imaging system for imaging a tubular comprising:
an imaging tool having a circumferentially-distributed phased array of ultrasound elements;
an electronic circuit connected to the phased array and arranged to: transmit ultrasound waves radially outwards towards the tubular, which waves are defocused with a coherent wavefront and steered at one of plural different steering angles; and
receive ultrasound reflections from the tubular for each of the steering angles, as digital reflection signals; and a processor arranged to:
perform receive-beamforming on the digital reflection signals to create plural steered ultrasound images.

2. The imaging system of claim 1, wherein the processor further combines the plural steered ultrasound images to create a compounded image of the tubular.

3. The imaging system of claim 1, wherein the processor further analyzes at least one of the plural steered ultrasound images to detect defects in the tubular.

4. The imaging system of claim 1, wherein the waves are planar waves or diverging curved waves.

5. The imaging system of claim 1, wherein the electronic circuit is arranged to transmit plural waves using different apertures of the ultrasound elements at the same time, without insonifying overlapping areas of an inner surface of the tubular.

6. The imaging system of claim 1, wherein the electronic circuit is arranged to transmit the ultrasound waves to insonify overlapping areas of an inner surface of the tubular from at least two of the different steering angles.

7. The imaging system of claim 1, wherein the electronic circuit is arranged to transmit the ultrasound waves as a continuous wavefront using substantially all of the ultrasound elements.

8. The imaging system of claim 1, wherein the plural steering angles comprise at least one perpendicular wavefront and two opposing, non-perpendicular wavefronts.

9. The imaging system of claim 1, wherein the electronic circuit is arranged to steer a given wave towards an inner surface of the tubular at a substantially consistent angle of incidence along the inner surface.

10. The imaging system of claim 1, wherein the electronic circuit is arranged to steer the waves to contact an inner surface of the tubular at angles of incidence of between 16 and 25°, offset azimuthally with respect to a surface normal of the tubular.

11. The imaging system of claim 1, wherein the circumferentially-distributed phased array is divided into plural segments of subarrays, preferably separated circumferentially by a gap or distributed as a helix or other pattern around the imaging tool.

12. The imaging system of claim 1, wherein the circumferentially-distributed phased array is divided into two or more bands of segments of subarrays, preferably which bands are offset from each other axially with respect to the imaging tool.

13. The imaging system of claim 1, wherein the circumferentially-distributed phased array is divided into plural segments of subarrays, some of which segments are angled partially in an axial direction of the imaging tool.

14. The imaging system of claim 1, wherein the processor performs receive-beamforming on the digital reflection signals in parallel.

15. A method of imaging a tubular using an imaging tool having a circumferentially-distributed phased array of ultrasound elements comprising the steps of:
deploying the imaging tool through the tubular;
transmitting ultrasound waves radially outwards towards the tubular steered at plural steering angles;
receiving ultrasound reflections from tubular for each of the plural steering angles as digital reflection signals;
performing receive beamforming on the digital reflection signals to create plural steered ultrasound images; and
combining the plural steered ultrasound images to create a compounded image of the tubular.

16. The method of claim 15, further comprising storing digital signals from the ultrasound elements of the received ultrasound reflections in a memory of the imaging tool and processing the digital signals on a remote computer, preferably storing the digitals signals as raw Rf signals.

17. The method of claim 15, further comparing the plural steered ultrasound images to determining eccentricity of the tubular.

18. The method of claim 15, wherein the transmitted ultrasound waves are planar waves.

19. The method of claim 15, wherein the transmitted ultrasound waves are diverging curved waves.

20. The method of claim 15, further comprising performing parallel receive-beamforming on the digital reflection signals to synthesize plural scanlines.

21. The method of claim 15, wherein at least one of the steering angles is selected based on geometry of the tubular to induce a shear wave in the tubular.

22. An industrial ultrasonic imaging system for imaging a tubular comprising:
an imaging tool having a circumferentially-distributed phased array of ultrasonic elements;
electronic circuits within the imaging tool and connected to the phased array and arranged to:
transmit ultrasound waves radially outwards towards the tubular; receive ultrasound reflections from the tubular, as digital reflection signals;
store the digital reflection signals on a memory within the imaging tool; and
transfer the stored digital reflection signals;
a computer remote from the imaging tool and arranged to:
receive the transferred digital reflection signals;
perform parallel receive-beamforming on the digital reflection signals to create ultrasound images; and
output the ultrasound images.

23. A method for imaging a tubular using an industrial ultrasonic imaging tool having a circumferentially-distributed phased array of ultrasonic elements, the method comprising:
transmitting ultrasound waves radially outwards towards the tubular;
receiving ultrasound reflections from the tubular, as digital reflection signals;
storing the digital reflection signals on a memory within the imaging tool;
transferring the stored digital reflection signals to a computer that is remote from the imaging tool;
using the remote computer, performing parallel receive-beamforming on the digital reflection signals to create ultrasound images; and
using the remote computer, outputting the ultrasound images.
